(19) United States
(12) Patent Application Publication
(10) Pub. No.: US 2020/0302407 A1
(43) Pub. Date: Sep. 24, 2020

(54) REAL-TIME RESOURCE SPLIT DISTRIBUTION NETWORK

(71) Applicant: BANK OF AMERICA CORPORATION, Charlotte, NC (US)

(72) Inventors: Therese H. Willis, Apopka, FL (US); Martha Sain McClellan, Lancaster, SC (US); Lee Ann Proud, Ponte Vedra, FL (US)

(73) Assignee: BANK OF AMERICA CORPORATION, Charlotte, NC (US)

(21) Appl. No.: 16/358,927

(22) Filed: Mar. 20, 2019

(51) Int. Cl. G06Q 20/02

(52) U.S. Cl. CPC G06Q 20/027

(57) ABSTRACT

Embodiments of the present invention provide a system with generated network for real-time split distribution of resource based on event execution and object deployment. In this way, the system identifies an event execution and large object deployment. Upon resource processing, the system translates RFI messaging within a real-time network for back end resource transmission to necessary upstream or downstream entity agents. Furthermore, the system provides a split processing for resource transmission to one or more entity agents. As such, the system provides a real-time resource distribution upon triggering object deployment for expedite resource distributions stemming from the event execution and object deployment.

### BACKGROUND

Event execution, object deployment, and subsequent resource distribution typically require timely communication between multiple systems and entities, with potential remedial measures being delayed. By building and deploying an interactive network for split distribution, real-time event execution, object deployment and resource distribution can be implemented for executed events without unnecessary and timely intermediary steps.

### BRIEF SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

In resource distribution processing networks, a need exists for a network construction for split distribution of resources based on real-time event execution and object deployment. In this way, resource distribution is performed in real-time to appropriate locations based on object deployment and event execution.

The invention utilize a network, such as a real-time payment processing network that includes message fields embedded within the processing transmissions. The messaging fields may be coded for transaction of identifying and completing inventory financing and payoff options. Various products and inventory may be paid by different levels around the entity, such as being paid store-by-store, corporate level, or the like. The system comprises a triggering event identification that triggers back to funds immediately available in a merchant account for each inventory product, such that the correct supplier, merchant, or the like is paid. For example, a car dealership may be able to provide resources upstream for a car manufacturer. In another example, the initial down payment for construction may be distributed to the appropriate contactors or sub-contractors. This system may also provide a split payment system on the backend, such that a merchant can pay multiple manufacturers from one supplier for similar products the merchant may be selling using a single inventory payment message with split payments for each manufacturer.

In some embodiments, the system may leverage the Request for Information (RFI) message within a real-time payment to directly request general information from the external financial institution about a specific RTN/ABA routing number, account number, or the like. The external financial institution will receive the split payment request via the RFI message and allows for performance of this communication on a backend secure RFI messaging center via secure network processing.

In this way, the system allows for connectivity across entities to share resource account information and allow for real-time resource split distribution based on event execution and object deployment.

Embodiments of the present invention address the above needs and/or achieve other advantages by providing apparatuses (e.g., a system, computer program product and/or other devices) and methods for real-time resource split distribution, the system comprising: identifying objects requiring upstream or downstream resource distribution upon event execution; generating coordinated resource distribution schedules for the upstream or downstream resource distributions; identifying an event execution and object deployment; generating a request for information message within a real-time network associated with the event execution and object deployment, wherein the request for information comprises the coordinated resource distribution schedules; and deploying of split resources from a single event execution and object deployment to multiple upstream or downstream entities based on decryption of the coordinated resource distribution schedules.

In some embodiments, generating coordinated resource distribution schedules for the upstream or downstream resource distributions further comprises identifying terms for resource distribution between upstream or downstream entities and the user, and conforming the terms to the coordinated resource distribution schedule, wherein the terms include a resource amount and an account for resource distribution.

In some embodiments, the upstream or downstream resource distributions include distributions to upstream or downstream entities associated with constructing or distributing the object for event execution and object deployment.

In some embodiments, the event execution and object deployment further comprises a product or service that require one or more upstream or downstream entities to be provided resources when the object is transacted for by a user.

In some embodiments, the request for information message associated with the real-time payment network further comprises a secure messaging platform for transmission of coordinated resource distribution schedules.

In some embodiments, the request for information message is transformed from being used in a transaction to being a communication linkage for transmission of coordinated resource distribution schedules.

The system of claim 1, wherein deploying of split resources from a single event execution and object deployment to multiple upstream or downstream entities based on decryption of the coordinated resource distribution schedules further comprises real-time distribution of resources to one or more accounts associated with the multiple upstream or downstream entities directly from a financial institution.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1A illustrates a diagram illustrating a system environment for real-time resource split distribution, in accordance with an embodiment of the invention.

FIG. 1B illustrates a block diagram illustrating a system environment for real-time resource split distribution, in accordance with an embodiment of the invention.

FIG. 2 provides a block diagram illustrating the spilt distribution system of FIG. 1B, in accordance with an embodiment of the invention;

FIG. 3 provides a block diagram illustrating the clearing house system of FIG. 1B, in accordance with an embodiment of the invention;

FIG. 4 provides a block diagram illustrating the computing device system of FIG. 1B, in accordance with an embodiment of the invention;

FIG. 5 provides a flowchart illustrating a process for providing a real-time resource split distribution network, in accordance with embodiments of the invention;

FIG. 6 provides a flowchart illustrating a process for resource processing via the split distribution network, in accordance with embodiments of the invention; and

FIG. 7 provides a flowchart illustrating a process for real-time resource processing, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

A “user” as used herein may refer to any customer of an entity or individual that interacts with an entity. The user may interact with an entity as a customer, such as a customer purchasing a product or service. Furthermore, as used herein the term “user device” or “mobile device” may refer to mobile phones, personal computing devices, tablet computers, wearable devices, and/or any portable electronic device capable of receiving and/or storing data therein.

As used herein, a “user interface” generally includes a plurality of interface devices and/or software that allow a customer to input commands and data to direct the processing device to execute instructions. For example, the user interface may include a graphical user interface (GUI) or an interface to input computer-executable instructions that direct the processing device to carry out specific functions. Input and output devices may include a display, mouse, keyboard, button, touchpad, touch screen, microphone, speaker, LED, light, joystick, switch, buzzer, bell, and/or other user input/output device for communicating with one or more users.

Further, the term “payment credential” or “payment vehicle,” as used herein, may refer to any of, but is not limited to refers to any of, but is not limited to, a physical, electronic (e.g., digital), or virtual transaction vehicle that can be used to transfer money, make a payment (for a service or good), withdraw money, redeem or use loyalty points, use or redeem coupons, gain access to physical or virtual resources, and similar or related transactions. For example, in some embodiments, the payment vehicle is a bank card issued by a bank which a customer may use to perform purchase transactions. However, in other embodiments, the payment vehicle is a virtual debit card housed in a mobile device of the customer, which can be used to electronically interact with an ATM or the like to perform financial transactions. Thus, it will be understood that the payment vehicle can be embodied as an apparatus (e.g., a physical card, a mobile device, or the like), or as a virtual transaction mechanism (e.g., a digital transaction device, digital wallet, a virtual display of a transaction device, or the like). The payment vehicle may be an unrestricted resource. Unrestricted resources, as used herein may be any resource that is not restricted for transaction. In this way, the unrestricted resources may be applied to any transaction for purchase of a product or service.

The invention utilize a network, such as a real-time payment processing network that includes message fields embedded within the processing transmissions. The messaging fields may be coded for transaction of identifying and completing inventory financing and payoff options. Various products and inventory may be paid by different levels around the entity, such as being paid store-by-store, corporate level, or the like. The system comprises a triggering event identification that triggers back to funds immediately available in a merchant account for each inventory product, such that the correct supplier, merchant, or the like is paid. For example, a car dealership may be able to provide resources upstream for a car manufacturer. In another example, the initial down payment for construction may be distributed to the appropriate contactors or sub-contractors. This system may also provide a split payment system on the backend, such that a merchant can pay multiple manufacturers from one supplier for similar products the merchant may be selling using a single inventory payment message with split payments for each manufacturer.

In an example, the real-time resource split distribution network system may be used when purchasing objects that require inventory financing or level payments. For example, if a user is purchasing a vehicle, this purchase may require the resource distribution to go to a sales person, a vehicle dealership, a vehicle distributor, a vehicle manufacturer, and component manufacturers, all associated with the manufacturing, distributing, and selling of the vehicle the user purchased. The system may generate a coordinated resource distribution schedule to include each of these entities and a resource amount to be provided to each of these entities upon sale of the vehicle. The coordinated resource distribution schedule may be translated and tagged within the transaction via the Request for Information (RFI) messaging platform available via the real-time payment network used for completion of the transaction for the vehicle. Upon receipt of the transaction information, a financial institution may process the transaction. The financial institution may also be coded for receiving and processing the RFI message. The message may contain the coordinated resource distribution schedule. As such, based on the schedule, the financial institution may distribute the allocated resources to each entity on the schedule based on the schedule coding.

In another example, the real-time resource split distribution network system may be used when performing operations for completion of a service object, such as completion of a construction project or the like. For example, if a user is purchasing a construction project, such as building a home, landscaping, or the like that may require resource distribution to be transmitted to a contractor, an architect, sub-contractors, material suppliers, rental entities, governmental entities, and the like all associated with the products, labor, and approval of the construction project.

The system may generate a coordinated resource distribution schedule to include each of these entities and a resource amount to be provided to each of these entities upon completion of one or more steps of the construction project. The coordinated resource distribution schedule may be translated and tagged within the transaction via the RFI messaging platform available via the real-time payment network used for completion of a transaction associated with one or more steps of the construction project. Upon receipt of the transaction information, a financial institution may process the transaction. The financial institution may also be coded for receiving and processing the RFI message. The message may contain the coordinated resource distribution schedule. As such, based on the schedule, the financial institution may distribute the allocated resources to each entity on the schedule based on the schedule coding.

The real-time payment network, upon utilization by multiple financial institutions, will have the data processing power of the third party services that aggregate the information from all financial institutions. Via the RFI text block tied to a transaction on the real-time payment network, financial institutions may be allowed to process and communicate split resource distributions within a single transaction. As such, the system may confirm, process, and distribute split payments within a single transaction layer. The system may identify the funding account and associated financial institution for each split and coordinate the transaction to each account associated with the split.

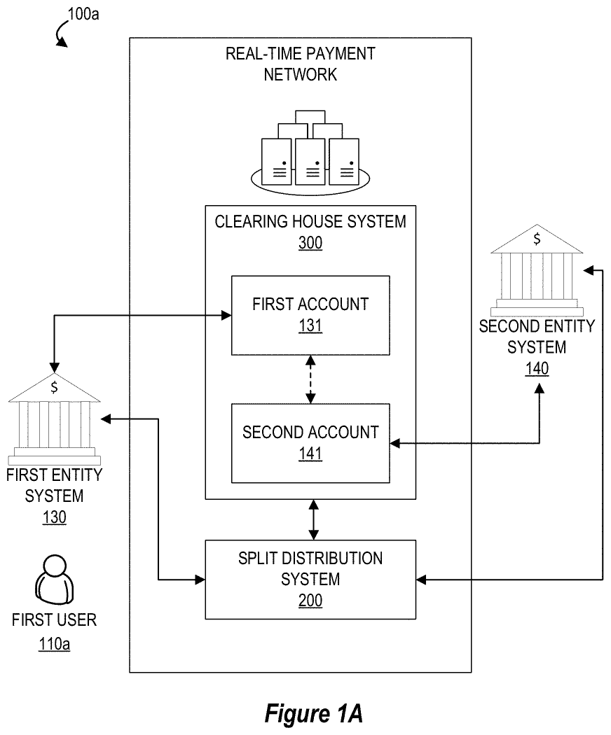

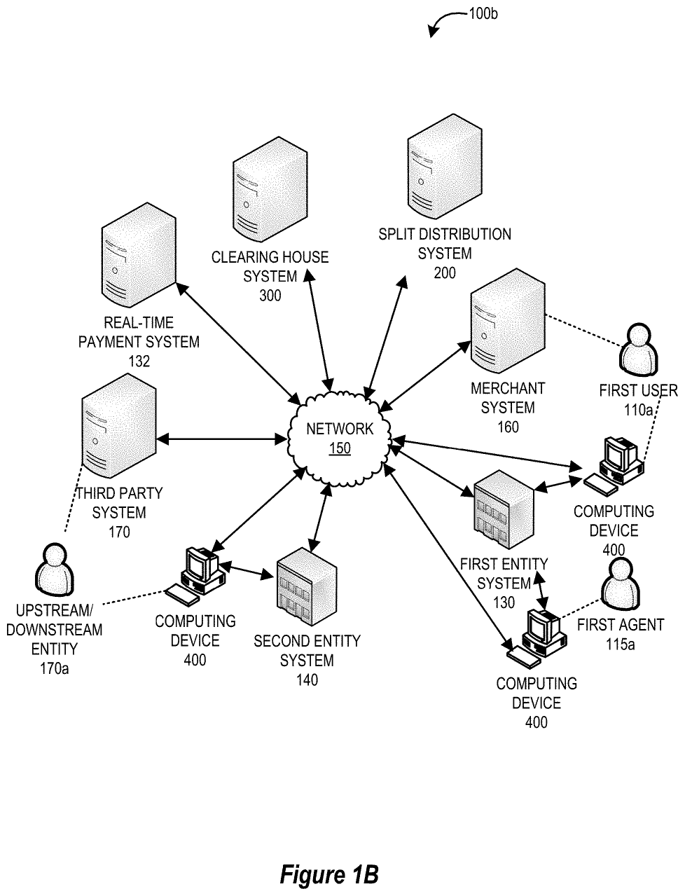

FIG. 1A illustrates a system environment for real-time resource split distribution 100a, in accordance with one embodiment of the invention. In some embodiments, the clearing house 300 is associated with the real-time payment network. In the illustrated environment, a user 110a is associated with (i.e., a customer of) a first entity system 130. A clearing house system 300 comprises a first entity account 131 associated with the first entity system 130 and a second entity account 141 associated with the second entity system 140. A split distribution system 200 that communicably links across the entities and clearing house to allow for split processing of a transaction occurring. The first entity account 131, the second entity account 141, and other entity accounts (not illustrated) are accessible by each associated financial institution, the split distribution system 200, and the clearing house system 300 which acts as a trusted intermediary during the verification, transfer, and settlement between the financial institutions. Resources or funds may be transferred by each financial institution to and from their associated account. Transfers between the first entity account 131, the second entity account 141, and other entity accounts are administered by the clearing house system 300 and split distribution system 200 pending authentication and authorization by participating parties of each transfer.

In one embodiment, the first user 110a may request an object or event execution of a second entity system 140. In a specific example, the first user 110a is required to initiate the transfer from the first entity system 130, wherein the first user 110a provides authentication information to authenticate the identity of the first user 110a and to validate that an account of the first user 110a held at the first entity system 130 contains at least a sufficient amount of available funds to fulfill funding account requirements.

The first user 110a, as the sending participant (i.e., payor), is required to authenticate his or her identity by providing information or credentials to the associated financial institution. For example, authentication information may include account numbers, routing numbers, PIN numbers, username and password, date of birth, social security number, or the like, or other authentication information as described herein. In some embodiments, authentication may comprise multi-factor or multi-step authentication in accordance with information security standards and requirements.

Upon initiating an interaction, the first user 110a becomes obligated to a status within a funding account for processing the product at the second entity system 140 associated with a second financial institution. The split distribution system 200 monitors the communications and confirms the communications and fund transfers into the accounts associated with the various upstream or downstream entities associated with the object accurately and provides expedited reconciliation of the transaction. The transfer of funds occurs between the first entity account 131 and the other entities associated with the object on behalf of the user, wherein the interaction may be settled immediately, concurrent with the interaction. As settlement occurs between the representative financial institutions, debiting and crediting of individual user and entity accounts may be managed at each financial institution with their associated customers. As the interaction is settled immediately, funds may be made available for use in real or near real-time.

It should be understood that while the illustrated embodiment of FIG. 1A depicts only a first user, financial institutions, and accounts, other embodiments of a real-time interaction network may comprise a plurality of accounts associated with a plurality financial institutions and a plurality of entities. In some embodiments, the system environment 100a may further comprise more than one clearing house system 300 (e.g., TCH, the Federal Reserve, and the like) that receive and process interaction requests as described herein. Financial institutions may include one or more community banks, regional banks, credit unions, corporate banks, direct connect financial institutions, and the like.

A “user interface” is any device or software that allows a user to input information, such as commands or data, into a device, or that allows the device to output information to the user. For example, the user interface include a graphical user interface (GUI) or an interface to input computer-executable instructions that direct a processing device to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users.

A “system environment”, as used herein, may refer to any information technology platform of an enterprise (e.g., a national or multi-national corporation) and may include a multitude of servers, machines, mainframes, personal computers, network devices, front and back end systems, database system and/or the like.

FIG. 1B provides a block diagram illustrating a system environment for real-time resource split distribution 100b. As illustrated in FIG. 1B, the environment 100 includes a real-time payment system 132, a split distribution system 200, a clearing house system 300, a first entity system 130, a second entity system 140, one or more computing device systems 400, a merchant system 160, and one or more third party systems 170 that is associated with and upstream or downstream entity 170a.

Embodiments of the present invention provide a system for real-time resource split distribution. In resource distribution processing networks, a need exists for a network construction for split distribution of resources based on real-time event execution and object deployment. In this way, resource distribution is performed in real-time to appropriate locations based on object deployment and event execution.

The invention utilize a network, such as a real-time payment processing network that includes message fields embedded within the processing transmissions. The messaging fields may be coded for transaction of identifying and completing inventory financing and payoff options. Various products and inventory may be paid by different levels around the entity, such as being paid store-by-store, corporate level, or the like. The system comprises a triggering event identification that triggers back to funds immediately available in a merchant account for each inventory product, such that the correct supplier, merchant, or the like is paid. For example, a car dealership may be able to provide resources upstream for a car manufacturer. In another example, the initial down payment for construction may be distributed to the appropriate contactors or sub-contractors. This system may also provide a split payment system on the backend, such that a merchant can pay multiple manufacturers from one supplier for similar products the merchant may be selling using a single inventory payment message with split payments for each manufacturer.

In some embodiments, the system may leverage the Request for Information (RFI) message within a real-time payment to directly request general information from the external financial institution about a specific RTN/ABA routing number, account number, or the like. The external financial institution will receive the split payment request via the RFI message and allows for performance of this communication on a backend secure RFI messaging center via secure network processing.

In this way, the system allows for connectivity across entities to share resource account information and allow for real-time resource split distribution based on event execution and object deployment.

One or more users, including a first user 110a, may be in network communication with the first entity system 130, the second entity system 140, or the other systems of the system environment 100b via a computing device system 400. The user may be a customer, client, patron, individual, business, or the like associated with the first entity system 130.

Similarly, one or more agents, including a first agent 115a may be in network communication with the first entity system 130, the second entity system 140, or the other systems of the system environment 100b via a computing device system 400. These agents may be employees, contractors, consultants, or the like, for the first entity system 130 and/or the second entity system 140 and performing work on or sale of the event or object.

Similarly, one or more upstream or downstream entities, including an upstream/downstream entity 170a may be in network communication with the third party system 170 or the other systems of the system environment 100b via a computing device system 400. These entities provide upstream or downstream processing of the object or objects associated with the event and receive resources upon execution of the event or distribution of the object.

The real-time payment system 132, split distribution system 200, the clearing house system 300, the first entity system 130, the second entity system 140, the one or more computing device systems 400, the merchant system 160, and the one or more third party systems 170 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet.

The split distribution system 200 may be a system owned or otherwise controlled by a managing entity to perform one or more process steps described herein. In some embodiments, the managing entity is a financial institution, a clearing house entity, a consortium of financial institutions and/or clearing house entities, or the like. While the split distribution system 200 is shown as a separate entity from other systems in the system environment 100b, it should be known that the managing entity may comprise one or more of the other systems in the system environment 100b.

In general, split distribution system 200 is configured to communicate information or instructions with the clearing house system 300, the first entity system 130, the second entity system 140, the one or more computing device systems 400, the merchant system 160, and/or one or more third party systems 170 across the network 150. Of course, the split distribution system 200 may be configured to perform (or instruct other systems to perform) one or more other process steps described herein.

As noted above with respect to FIG. 1A, the clearing house system 300 may be a system owned or controlled by the managing entity and/or a third party that specializes in maintaining financial accounts, performing financial transaction clearing house functions, generating and/or transmitting financial transaction messages, and the like. In general, the clearing house system 300 is configured to communicate information or instructions with the real-time payment system 132, split distribution system 200, the first entity system 130, the second entity system 140, the one or more computing device systems 400, the merchant system 160, and/or the third party system 170 across the network 150. For example, the clearing house system 300 may be configured to receive a message from a computing device system 400 associated with the first user 110a and/or the first entity system 130, transfer an event amount from an account of the first entity system 130 to an account of the second entity system 140, record event information in a clearing house database system, receive a request for the event information along with an event request indicia, and/or extract and transmit the event information stored in the clearing house database system Of course, the clearing house system 300 may be configured to perform (or instruct other systems to perform) one or more other process steps described herein.

The one or more computing device system(s) 400 may be a system owned or controlled by the managing entity, a merchant entity (e.g., a merchant associated with the merchant system 160) and/or a third party that specializes in providing computing devices and/or mobile computing devices to users. In general, a computing device system 400 is configured to provide a communication and/or transaction interface for the first user 110a to provide instructions to, or receive notifications from, the real-time payment system 132, split distribution system 200, the clearing house system 300, the first entity system 130, the second entity system 140, the merchant system 160, and/or the third party system 170 across the network 150. For example, the computing device system 400 associated with the first user 110a may be configured to receive an event request from the first user 110a, generate a message based on the event request (e.g., via an event application stored in the memory of the computing device system 400), and transmit the message and/or event request to the first entity system 130. Of course, the computing device system 400 may be configured to perform (or instruct other systems to perform) one or more other process steps described herein.

The first entity system 130 may comprise a network communication interface, a processing device, and one or more memory devices, where the processing devices are configured to perform certain actions with the memory devices and communicate these actions to the rest of the network 150 through its network communication interface. In some embodiments, the first entity system 130 comprises a financial institution at which the first user 110a is a customer. The first entity system 130 may have one or more financial accounts that are available to, at least partially controlled by, or otherwise accessible by the clearing house system 300 such that the clearing house system 300 is pre-authorized to execute transactions with the account of the first entity system 130 upon receipt of messages from the first entity system 130, the second entity system 140, and/or the first user 110a.

The second entity system 140 may comprise a network communication interface, a processing device, and one or more memory devices, where the processing devices are configured to perform certain actions with the memory devices and communicate these actions to the rest of the network 150 through its network communication interface. The second entity system 140 may have one or more financial accounts that are available to, at least partially controlled by, or otherwise accessible by the clearing house system 300 such that the clearing house system 300 is pre-authorized to execute transactions with the account of the second entity system 140 upon receipt of messages from the first entity system 130, the second entity system 140, and/or the first user 110a.

The merchant system 160 may be a system owned, operated, managed, or otherwise controlled by a merchant entity (e.g., a business or individual that offers goods or services in return for payment). The merchant system 160 may include or comprise a computing device system 400 as described herein. In some embodiments, the computing device system 400 of the merchant system 160 comprises a point of sale (POS) device or system of devices, barcode scanning devices, universal product code (UPC) scanners, receipt generating and/or printing devices, security video monitoring system devices, card reading devices, near field communication (NFC) chip reading devices, or other transaction, security, or recording devices that the merchant entity can use to process or document a transaction between the merchant entity and a user (e.g., the first user 110a).

The merchant system 160 may be configured to begin processing certain transactions with the first user 110a by receiving payment information of the first user 110a (e.g., scanning a financial instrument like a credit card of the user 110a that is associated with a financial account of the first user 110a, receiving a transmission of financial account information from the computing device system 400 of the user 110a, receiving payment credentials of the first user 110a via an online merchant portal established or managed by the merchant system 160, or the like). The merchant system 160 may then transmit transaction information to the first entity system 130 (and not through a traditional credit or debit card processing network), either by providing the transaction information to the first agent 115a or by entering the transaction information into a predetermined template that the first entity system 130 is configured to automatically convert into a message for the clearing house system 300 and/or the second entity system 140.

In some embodiments, the merchant system 160 is configured to record, assign, store, or otherwise transmit certain transaction information across the network 150 to the clearing house database system or to an event database of the first entity system 130 and/or the second entity system 140. For example, the system may store a record of one or more products purchased, time-stamp information for the transaction, an image or video of an individual associated with the transaction, financial instrument information for the transaction, terms and conditions of sale, an image or digital copy of the merchant receipt, an image or digital copy of the first user's 110a receipt, return policy documentation, loyalty rewards policy information and documentation, and the like. This information may, in some embodiments, be considered at least a part of the additional information of a message, as described herein.

While the merchant system 160 may be configured to initiate a transaction within the system environment 100b, it should be known that the merchant system 160 may additionally be considered the first user 110a. For example, the merchant system 160 may manage a transaction with an individual that triggers a transmission of a loyalty reward of a discount code, a rebate, and/or other additional information. The merchant system 160 may then take the place of the first user 110a in the system environment 100b to initiate a new transaction or event, via the first entity system 130 and the clearing house system 300. In another example, the first user 110a is an individual that enters into a transaction with the merchant system 160 via a computing device system 400 of the merchant system 160, where the payment is processed via the first entity system 130 and the clearing house system 300 to the second entity system 140 that ultimately pays the merchant system 160.

The third party system 170 may be any system that is in communication with the network 150 and executes one or more functions or process steps of the processes described herein with respect to the system environment 100b. The third party system 170 may be associated with the merchant system 160 and/or other entities involved in the upstream or downstream processing of the object, such as contractors, sub-contractors, manufacturers, distribution agents, or the like.

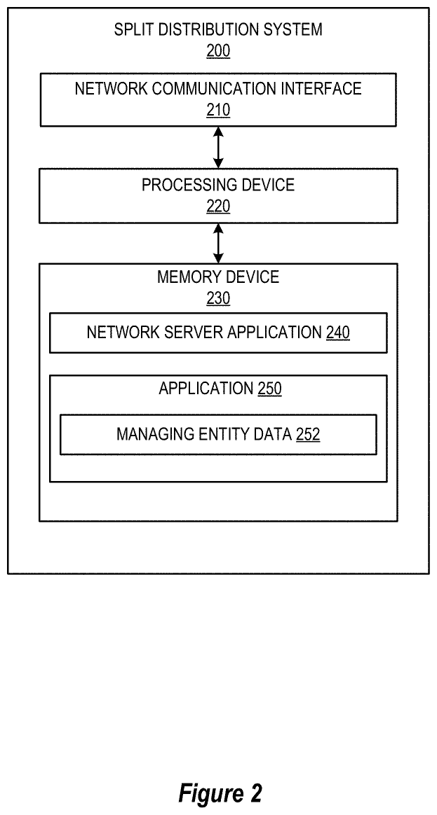

FIG. 2 provides a block diagram illustrating the split distribution system 200, in greater detail, in accordance with embodiments of the invention. As illustrated in FIG. 2, in one embodiment of the invention, the split distribution system 200 includes one or more processing devices 220 operatively coupled to a network communication interface 210 and a memory device 230. In certain embodiments, the split distribution system 200 is operated by a first entity, such as a financial institution, while in other embodiments, the split distribution system 200 is operated by an entity other than a financial institution.

It should be understood that the memory device 230 may include one or more databases or other data structures/repositories. The memory device 230 also includes computer-executable program code that instructs the processing device 220 to operate the network communication interface 210 to perform certain communication functions of the split distribution system 200 described herein. For example, in one embodiment of the split distribution system 200, the memory device 230 includes, but is not limited to, a network server application 240, a reconciliation application 250 which includes reconciliation data 252 and other computer-executable instructions or other data. The computer-executable program code of the network server application 240 and/or the reconciliation application 250 may instruct the processing device 220 to perform certain logic, data-processing, and data-storing functions of the split distribution system 200 described herein, as well as communication functions of the split distribution system 200.

The application 250 may be configured to invoke or use the data 252 to perform one or more processes and functions of the other systems (i.e., the clearing house system 300, the first entity system 130, the second entity system 140, the merchant system 160, the third party system 170, and/or the one or more computing device systems 400) within the system environment 100b, as defined or described herein.

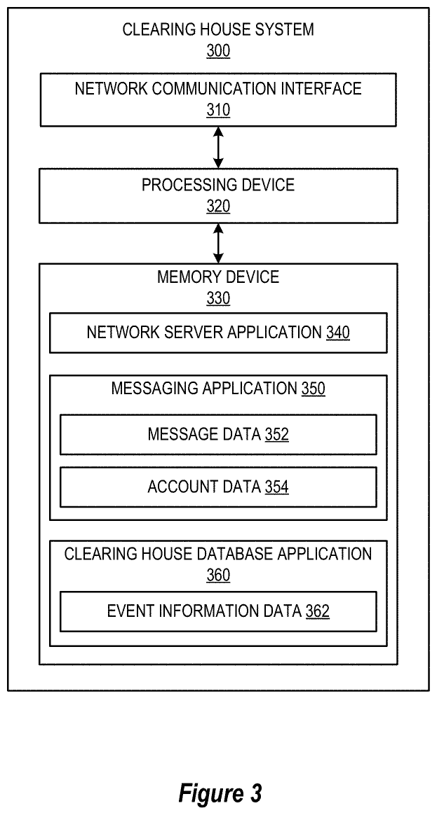

FIG. 3 provides a block diagram illustrating the clearing house system 300, in greater detail, in accordance with embodiments of the invention. As illustrated in FIG. 3, in one embodiment of the invention, the clearing house system 300 includes one or more processing devices 320 operatively coupled to a network communication interface 310 and a memory device 330. In certain embodiments, the clearing house system 300 is operated by a first entity, such as a financial institution, while in other embodiments, the clearing house system 300 is operated by an entity other than a financial institution.

It should be understood that the memory device 330 may include one or more databases or other data structures/repositories. The memory device 330 also includes computer-executable program code that instructs the processing device 320 to operate the network communication interface 310 to perform certain communication functions of the clearing house system 300 described herein. For example, in one embodiment of the clearing house system 300, the memory device 330 includes, but is not limited to, a network server application 340, a messaging application 350 which includes message data 352 and account data 354, a clearing house database application 360 which includes event information data 362, and other computer-executable instructions or other data. The computer-executable program code of the network server application 340, the messaging application 350, and/or the clearing house database application 360 may instruct the processing device 320 to perform certain logic, data-processing, and data-storing functions of the clearing house system 300 described herein, as well as communication functions of the clearing house system 300.

In one embodiment, the messaging application 350 includes message data 352 and account data 354. The message data 352 may comprise instructions, terms, amounts, descriptions, content, and other information that is to be transferred from a first entity system to another entity system via a notification and/or as a transaction between accounts of each entity system. The account data may include account numbers, pre-authorization data, account limits or other threshold information, and the like that allows the clearing house system 300 to automatically transfer funds from a first entity system's account to a second entity system's accounts without additional approvals or confirmations from the entities, based on instructions provided to the clearing house system 300 via a received message.

In one embodiment, the clearing house database application 360 includes event information data 362. This event information data 362 may include documents, contracts, agreements, user generated or curated content, media, files, notifications, memorandum, notes, and other information that is associated with one or more events that are processed by the clearing house system 300. The clearing house database application 360 may be configured to access its database and identify event information based on received inputs of reference numbers, passcodes, database index positions, public blockchain keys, and the like.

The network server application 340 the messaging application 350, and the clearing house database application 360 are configured to invoke or use the message data 352, the account data 354, the event information data 362, and the like when communicating through the network communication interface 310 with the real-time payment system 132, the split distribution system 200, the one or more computing device systems 400, the first entity system 130, the second entity system 140, the merchant system 160, and/or the third party system 170.

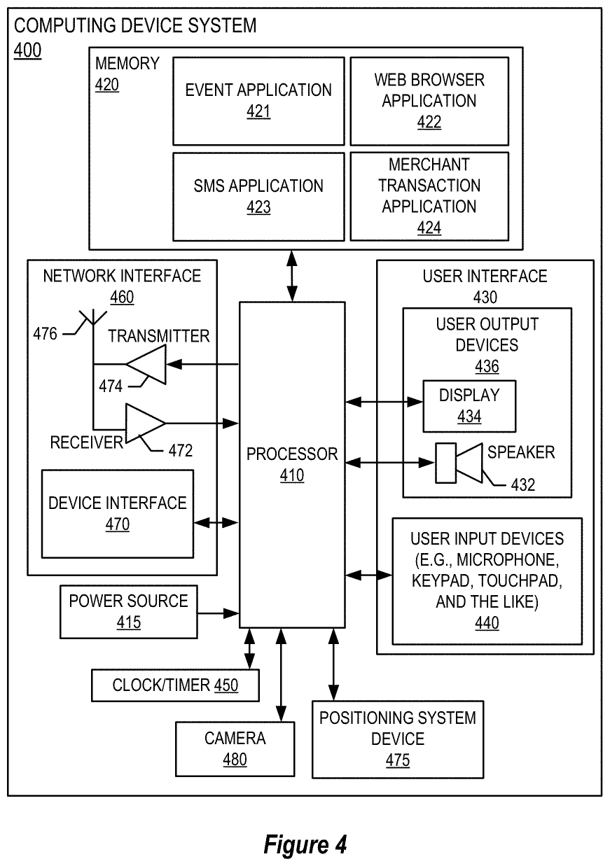

FIG. 4 provides a block diagram illustrating an example computing device system 400 of FIG. 1B in more detail, in accordance with embodiments of the invention. In one embodiment of the invention, the computing device system 400 is a mobile telephone. However, it should be understood that a mobile telephone is merely illustrative of one type of computing device system 400 that may benefit from, employ, or otherwise be involved with embodiments of the present invention and, therefore, should not be taken to limit the scope of embodiments of the present invention. Other types of computing devices may include portable digital assistants (PDAs), pagers, mobile televisions, gaming devices, desktop computers, workstations, laptop computers, cameras, video recorders, audio/video player, radio, GPS devices, wearable devices, Internet-of-things devices, augmented reality devices, virtual reality devices, automated teller machine devices, electronic kiosk devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of a wireless network. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like. For example, the computing device system 400 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA split distribution system 2000, wideband CDMA (WCDMA) and/or time division-synchronous CDMA (TD-SCDMA), with fourth-generation (4G) wireless communication protocols, with LTE protocols, with 4GPP protocols and/or the like. The computing device system 400 may also be configured to operate in accordance with non-cellular communication mechanisms, such as via a wireless local area network (WLAN) or other communication/data networks.

As described above, the computing device system 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410.

The user input devices 440, which allow the computing device system 400 to receive data from a user such as the user 110, may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RF ID tag, that can sense or be sensed by devices known to be located proximate a merchant or other location to determine that the computing device system 400 is located proximate these known devices.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422 and/or an event application 421 (or any other application provided by the split distribution system 200 and/or the clearing house system 300). These applications also typically instructions to a graphical user interface (GUI) on the display 430 that allows the user 110 to interact with the computing device system 400, the split distribution system 200, and/or other devices or systems. In one embodiment of the invention, when the user (e.g., user 110a) decides to enroll in an event application 421 program, the user downloads, is assigned, or otherwise obtains the event application 421 from the split distribution system 200, the clearing house system 300, the first entity system 130, the second entity system 140, or from a distinct application server. In other embodiments of the invention, the user 110 interacts with the real-time payment system 132, split distribution system 200, the clearing house system 300, the first entity system 130, the second entity system 140, a third party system, or another computing device system 400 via the web browser application 422 in addition to, or instead of, the event application 421.

The event application 421 may be configured to transmit and receive messages, notifications, calls, electronic mail messages, and the like, between a user and an entity associated with the event (e.g., a first entity system, a second entity system, and/or a clearing house system). In this way, the event application 421 acts as a communication interface that allows the user to perform any of the user-controlled or initiated actions described herein.

The memory 420 of the computing device system 400 may comprise a Short Message Service (SMS) application 423 configured to send, receive, and store data, information, communications, alerts, and the like via a wireless telephone network.

In embodiments where the computing device system 400 is owned, managed, or otherwise controlled by the merchant system 160, the memory 420 may include a merchant transaction application 424 that is configured to perform certain tasks associated with identifying products or services being purchased, initiating the processing of financial instruments being used to purchase the products or services, generating receipt information associated with transactions, recording supplemental information associated with products or services being purchased, and the like. For example, the merchant transaction application 424 may be configured to scan barcode information or otherwise identify a UPC for a product being purchased at a merchant location. The merchant transaction application 424 may additionally be configured to cause the camera 480 to acquire an image and/or video media of a region around or associated with a point of sale terminal (e.g., a component of the computing device system 400 of the merchant system 160) to record information about an individual engaging in a transaction with the merchant entity, and this media can be stored or otherwise recorded as additional information for the transaction or event.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein.

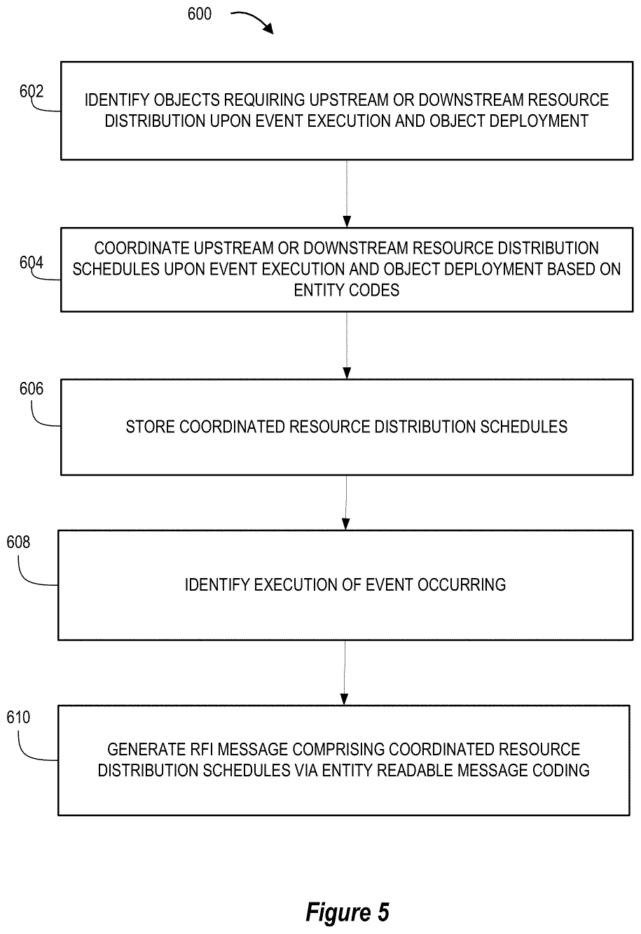

FIG. 5 provides a flowchart illustrating a process for providing a real-time resource split distribution network 600, in accordance with embodiments of the invention. As illustrated in block 602, the process 600 is initiated by identifying objects within an inventory that requires upstream or downstream resource distribution upon event execution and object deployment. The objects may include a product, service, or the like that may require inventory financing for the merchant, a level payment scale, and/or the like that require various payment to upstream or downstream entities, such as manufacturers, distributors, contractors, sub-contractors, or the like. Event execution may include an object being purchased, a step in a process to product/service completion has been achieved, or the like. Object deployment may include one or more objects being deployed to a user, completion and confirmation of completion of a step in the process, or the like.

Next, as illustrated on block 604, the process 600 continues by coordinating upstream or downstream resource distribution schedules for use when event execution and object deployment occurs. As such, upstream or downstream entities may have resources distributed to them upon event execution. These entities may include distributors, manufactures, contractors, material suppliers, sub-contractors or the like associated with a product or service being transacted for. The system may identify the terms for payment for each of these entities and generate a coordinated resource distribution schedule that may be deployed upon object deployment and/or event execution, such as the purchase of a product, the purchase of a service, or the completion of a step of a service.

As illustrated in block 606, the process 600 continues by storing the coordinated resource distribution schedules based on the object or event. As such, upon triggering of the object distribution or event execution, the system may be able to deploy the coordinated resource distribution schedules at that time.

Next, as illustrated in block 608, the process 600 continues by identifying that the execution of an event or the distribution of an object is occurring. In this way, the system may recognize when a transaction is being performed for an object and/or when a stage in a project is being initiated or completed that requires resource distribution. The identification may be based on merchant indication, user indication, financial institution indication (based on resource procurement for the object), or the like.

Finally, as illustrated in block 610, the process 600 is completed by generating a Request of Information (RFI) message that comprises the coordinated resource distribution schedules for the identified event execution or object deployment. The RFI message may be formatted in an entity readable message coding. The RFI message is a tag that is associated with the transaction processing for the object via a real-time payment processing rail.

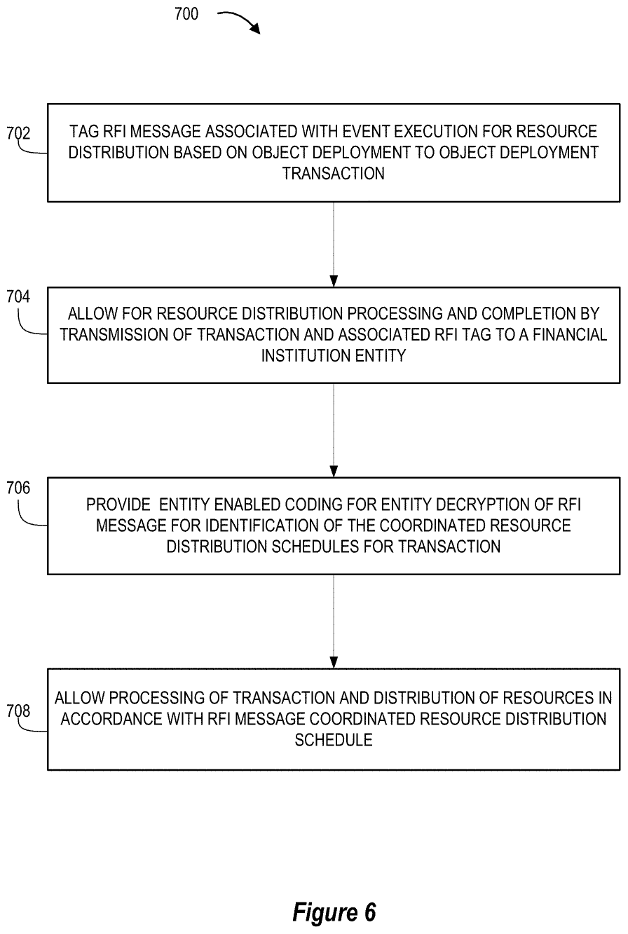

FIG. 6 provides a flowchart illustrating a process for resource processing via the split distribution network 700, in accordance with embodiments of the invention. As illustrated in block 702, the process 700 is initiated by tagging the RFI message associated with the event execution for resource distribution based on object deployment to the object deployment transaction. In this way, the merchant may request a resource payment from the user to complete the transaction for the object. The financial institution associated with one or more of the merchant or the user may process the payment via a real-time payment network. The system may utilize the RFI text message available within the real-time payment network to generate and deploy the coordinated resource distribution schedule within the tagged RFI message. As such, as the transaction is being processed the resource distribution schedule may be carried along with the transaction for processing.

Next, as illustrated in block 704, the process 700 continues by allowing for resource distribution processing and completion by transmission of the transaction and associated RFI tag to a financial institution entity. In this way, the system may allow for transaction processing via a real-time payment network that includes a RFI text field. The system may deploy the coordinated resource distribution schedules on the RFI text field and tag it to the transaction processing. As such, the processing rail and processing financial institution may be able to identify and process the schedule and provide resources to the appropriate upstream or downstream entity.

As illustrated in block 706, the process 700 continues by providing the financial institution entity with enabled coding for the financial institution to decrypt the RFI message for entity identification of the coordinated resource distribution schedules for the transaction. As such, the coordinated resource distribution schedules may comprise names for resource distribution, accounts for resource distribution, and amounts for distribution into each account.

Next, as illustrated in block 708, the process 700 is finalized by allowing the processing of the transaction and distribution of resources in accordance with the RFI message coordinated resource distribution schedule.

In some embodiments, the system allows for user control to stop payments to one or more upstream or downstream entities. As such, if an entity doesn't perform an object execution, the user may be able to stop the payment to that entity.

In an example, the real-time resource split distribution network system may be used when purchasing objects that require inventory financing or level payments. For example, if a user is purchasing a vehicle, this purchase may require the resource distribution to go to a sales person, a vehicle dealership, a vehicle distributor, a vehicle manufacturer, and component manufacturers, all associated with the manufacturing, distributing, and selling of the vehicle the user purchased. The system may generate a coordinated resource distribution schedule to include each of these entities and a resource amount to be provided to each of these entities upon sale of the vehicle. The coordinated resource distribution schedule may be translated and tagged within the transaction via the Request for Information (RFI) messaging platform available via the real-time payment network used for completion of the transaction for the vehicle. Upon receipt of the transaction information, a financial institution may process the transaction. The financial institution may also be coded for receiving and processing the RFI message. The message may contain the coordinated resource distribution schedule. As such, based on the schedule, the financial institution may distribute the allocated resources to each entity on the schedule based on the schedule coding.

In another example, the real-time resource split distribution network system may be used when performing operations for completion of a service object, such as completion of a construction project or the like. For example, if a user is purchasing a construction project, such as building a home, landscaping, or the like that may require resource distribution to be transmitted to a contractor, an architect, sub-contractors, material suppliers, rental entities, governmental entities, and the like all associated with the products, labor, and approval of the construction project.

The system may generate a coordinated resource distribution schedule to include each of these entities and a resource amount to be provided to each of these entities upon completion of one or more steps of the construction project. The coordinated resource distribution schedule may be translated and tagged within the transaction via the Request for Information (RFI) messaging platform available via the real-time payment network used for completion of a transaction associated with one or more steps of the construction project. Upon receipt of the transaction information, a financial institution may process the transaction. The financial institution may also be coded for receiving and processing the RFI message. The message may contain the coordinated resource distribution schedule. As such, based on the schedule, the financial institution may distribute the allocated resources to each entity on the schedule based on the schedule coding.

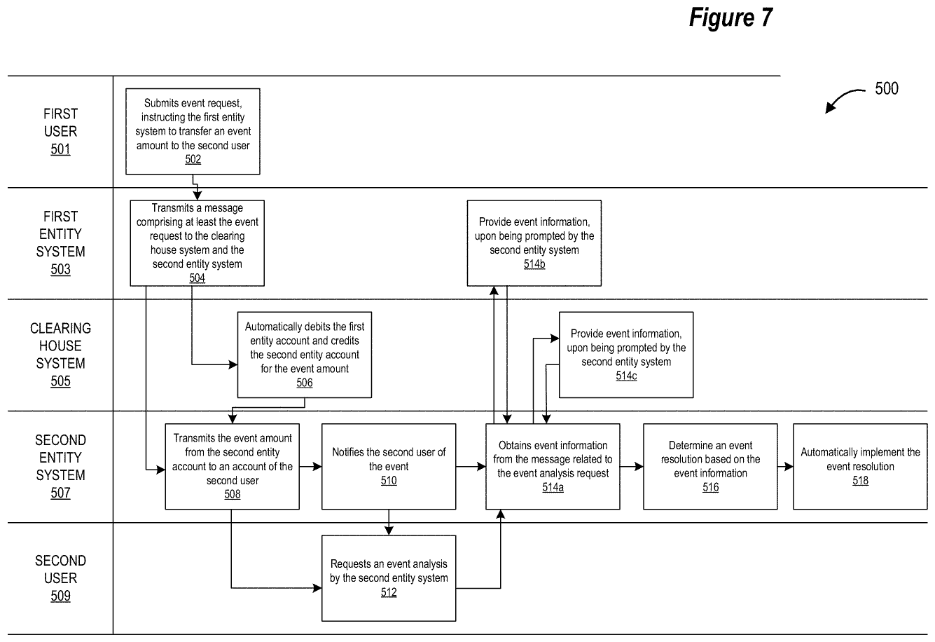

As illustrated, the real-time resource split distribution network, in some embodiments, utilizes a real-time payment network processing system for message distribution. Referring now to FIG. 7, a flowchart is provided to illustrate one embodiment of a process for real-time resource processing 500, in accordance with embodiments of the invention. FIG. 7 illustrates processing a payment across the real-time payment network. This system utilizes the network for message generation and verification across the same network without completion of a transaction, but instead utilization of the messaging processing available across the real-time payment network with a secure processing and secure commutations network. FIG. 7 illustrates a resource transfer or fund transfer via a real-time payment network rail. As shown in FIG. 7, the parties, entities, and/or systems involved in this process 500 may comprise a first user 501 (interacting via a computing device), a first entity system 503 of which the first user 501 is a customer, a clearing house system 505 associated with the real-time payment network for processing transactions in real-time, a second entity system 507, and a second user 509 that is a customer of the second entity system 507. Overall, this process 500 describes how an event (e.g., at least a transfer of funds from the first user 501 to the second user 509) is requested, analyzed, and resolved via a real-time payment network with resource reconciliation.

In some embodiments, an event comprises a payment or other financial transaction, where the first user 501 is paying the second user 509 (and/or multiple other upstream or downstream entities) a transaction amount, so a financial institution (i.e., the first entity system 503) associated with the first user 501 transmits the transaction amount and a message to a financial institution (i.e., the second entity system 507) associated with the second user 509, where the transaction amount is then transferred to an account of the second user 509. The second user 509 may then have a question, concern, or the like regarding the transaction (e.g., regarding the amount of the transaction, the timing of the transaction, the reason for the transaction, and the like). The second user 509 can then request its financial institution to analyze the transaction, determine a resolution, and automatically implement the resolution.

In some embodiments, the process 500 may begin at block 502, where the first user 501 submits an event request such as a real-time payment request to transfer resources, instructing the first entity system to transfer an event amount to the second user.

Again, the event may comprise a transaction of an amount of resources from an account of the first user 501 held by the first entity system 503 to an account of the second user 509 held by the second entity system 507. The request may further be performed via a real-time payment network and include information about the event, background details regarding the event, a contract or other agreement associated with the event (e.g., detailing a transaction that should occur between the first user 501 and the second user 509), content created or curated by the first user 501 (e.g., electronic messages, documents that may be useful to the second user 509, or the like), coupons, rebates, or offers for the second user, receipts associated with the event (e.g., an electronic receipt, invoice, or other recordation of the occurrence of a separate part of the transaction), a memorandum drafted by the first user, or the like.

In some embodiments, the information associated with the event may comprise one or more large data files or require a considerable amount of processing power or resources to transfer the entirety of the event information as part of the event request.

In some embodiments, the process 500 includes block 504, where the first entity system 503 transmits a message comprising at least the event request to the second entity system 507 via the real-time payment network. In some embodiments, the message was generated by the first user 501, either organically or by the first user 501 populating and/or adding to a message template created by the first entity system 503. In some embodiments, an agent of the first entity may receive the event request and generate at least a portion of the message based on the event request. In this way, the agent of the first entity system (e.g., a claims investigation specialist, a transaction specialist, or the like) may be specialized in assisting users like the first user 501 in requesting and/or generating event requests.

As noted, the message comprises at least the event request, which could be a request to transfer a certain amount of funds from an account of the first user 501 to an account of the second user 509. However, the message may also comprise some additional event information including, but not limited to, an explanation of the purpose of the event (e.g., payment for goods or services, rent, payment of an insurance claim, annuity payment, refund, or the like), background information for the event (e.g., a contract or agreement for providing the payment in exchange for goods or services, a contract or agreement for an insurance claim that is being paid, or the like), content created or curated by the first user 501 and/or the first entity system 503 (e.g., discount codes, coupons, digitally autographed work product, or digital copies of work product like articles, movies, books, and/or the like).

At this point, or prior to transmitting the message in block 504, the first entity system 503 may debit an identified account of the first user for the event amount and credit an account of the first entity which may be an account that is associated with the clearing house system 505.

Additionally, in some embodiments, the process 500 includes block 506 that comprises automatically debiting the first entity account and credits the second entity account for the event amount. As described above, both the first entity system 503 and the second entity system 507 have one or more accounts (e.g., financial accounts, data repositories, and/or the like) to automatically debit and/or credit upon instructions or requests found in messages. Because the clearing house system 505 is pre-authorized to perform these transactions, the clearing house system 505 can automatically execute transactions between these accounts in real-time or near real-time as messages with transfer requests are received.

In some embodiments, the clearing house system 505 may additionally or alternatively transmit one or more data files, documentation, reference numbers, database index positions, passcodes, website links, or the like (i.e., “content”) from one account or messaging platform to another account or messaging portal. For example, in response to instructions found in the message from the first entity system 503, the clearing house system 505 may transfer a copy of an insurance claim document related to the event request and event amount from a database associated with the first entity system 503 to a database associated with the second entity system 507. The content be in transferred within the message in a complete form that is readable by an application of a computing device of the second entity system 507 and/or a computing device of the second user 509. In other embodiments, the message may contain a reference number or passcode associated with the content that the clearing house system 505, the second entity system 507, and/or the second user 509 can provide to the first entity system 503 and/or the clearing house system 505 to prompt the first entity system 503 and/or the clearing house system 505 to transmit the complete version of the content.

As shown at block 508, the second entity system 507 may then transmit the event amount from the second entity account to an account of the second user 509. As the clearing house system 505 only has access to the accounts of the first entity system 503 and the second entity system 507 (e.g., financial institutions), the second entity system 507 would need to make the final transmittal of the event amount from its account associated with the clearing house system 505 to the account of the second user 509 specified by the first user 501 in the event request (as instructed by the message). Because the second entity system 507 will have received the event amount in real-time (or near real-time) from the clearing house system 505 in response to the message transmittal, the second entity system 507 can automatically transmit this event amount in real-time or near real-time to the account of the second user 509.

The second entity system 507 can then notify the second user 509 of the event, including a notification that the event amount has been credited to the account of the second user 509, as shown at block 510. This notification may comprise details of the event, as input by the first user 501, may comprise a copy of the message, may comprise one or more items from transmitted content, or the like. The second user 509 can review this notification, including the event amount transferred to the account of the second user 509, and determine if the event is what the second user 509 expected.

If the second user 509 has questions about the event, believes there was a mistake in the processing of the event request by the first user 501, the first entity system 503, the clearing house system 505, and/or the second entity system 507, or if the first user 501 would like more information or content associated with the event, then the first user 501 may request an event analysis from the second entity system 507, as shown at block 512. While block 512 illustrates that the second user 509 requests an event analysis from the second entity system 507, it should be known that this event analysis request may be made to the clearing house system 505 and/or the first entity system 503. As such, the steps illustrated by blocks 514a, 516, and/or 518 may be executed by the clearing house system 505 and/or the first entity system 503 instead of, or in addition to, the second entity system 507.

The event analysis request may be made by the second user 509 by contacting the second entity system 507 via an online portal of the second entity system 507, a computing device application of the second entity system 507, by calling an agent of the second entity system 507, by messaging an agent of the second entity system 507, or the like. The event analysis request may comprise a request for investigation of a claim, a request for investigation of a transaction, an audit request, a request for additional information regarding a transaction, a request for certain content associated with the event, and the like. In some embodiments, an agent associated with the second entity system 507 may generate or otherwise initiate the event request on behalf of the second user 509, or conduct the event analysis for testing, customer support, or other purposes that are beneficial to the second entity system 507 and/or the second user 509.

As an example of block 512, the account of the second user 509 may have received a certain amount of funds (i.e., the event amount) from an insurance entity (i.e., the first user 501) that is a fraction of what the second user 509 expected to receive as part of a previously submitted insurance claim. The second user 509 has received the notification from the second entity system 507 that listed the certain amount of funds that the second user 509 has received, and a brief note that the certain amount of funds was provided by the insurance entity pursuant to the previously submitted insurance claim. As the second user 509 expected a different amount of funds to be transferred, the second user 509 submitted an event analysis request to see whether there was an error in the transaction processing stages, or whether there is more information about the claim that would explain why the certain amount of funds was provided instead of the expected amount of funds.

As shown at block 514a, the second entity system 507, in response to receiving the event analysis request, obtains event information from the message that is related to the event analysis request. As noted above, the event information may comprise documentation regarding the event, contracts associated with the event, files or media associated with the event, or the like. In embodiments where the entirety of the event information is provided in the message (e.g., included within the body of the message or as an attachment to the message), then the second entity system 507 can extract the event information from the message and identify the event information that is related to the event analysis request.

However, as noted above, the first user 501, the first entity system 503, and/or the clearing house system 505 may have stored at least a portion of the event information in a database and instead included a reference number, a passcode, a database index position, or the like (individually or collectively “event information indicia”) in the message.

In embodiments where the first user 501 and/or the first entity system 503 stored at least a portion of the event information in a first entity system 503 database, the second entity system 507 can request the event information from the first entity system 503, along with the event information indicia identified by the second entity system 507 in the message. The first entity system 503 will then automatically identify, extract (e.g., copy, move, or the like), and provide (e.g., transfer) the event information from its database upon being prompted by the second entity system 507, as shown at block 514b. For example, the second entity system 507 may transmit a request for the event information with a reference number for the event, the first entity system 503 automatically compares the reference number to an internal database to identify which information stored in its database is associated with the reference number, copy the associated event information, and transmit the event information to the second entity system 507 via a secured communication channel. It should be known that one or more of the processes described with respect to block 514b may be executed manually by an agent of the first entity system 503.

In embodiments where the clearing house system 505 has stored the event information in a database that the second entity system 507 does not have direct access to, then the second entity system 507 will transmit an event information request to clearing house system 505, along with the event information indicia identified by the second entity system 507 in the message. The clearing house system 505 will then automatically identify, extract (e.g., copy, move, or the like), and provide (e.g., transfer) the event information from its database upon being prompted by the second entity system 507, as shown at block 514c.

In other embodiments, where the second entity system 507 has access to a clearing house database 511 where the event information is stored (e.g., as indicated by the message), then the second entity system 507 may interact directly with the clearing house database 511 to identify and extract the event information. For example, if the second entity system 507 identifies a database index position of the event information for the clearing house database 511 within the event message, then the second entity system 507 may navigate to the identified database index position within the clearing house database 511 to identify the event information. In some embodiments, the event information may be further protected or encrypted within the clearing house database 511, such that the second entity system 507 is required to provide a passcode, a decryption key, or the like (e.g., as found in, or determined from, the event message) to gain full access to the event information within the event database.

Once the second entity system 507 has access to (or copies of) the event information associated with the event analysis request, the second entity system 507 may determine an event resolution based on the event information, as shown at block 516. The event resolution may comprise a determination that a processing error occurred, and additional funds should be transferred from the account of the first entity system 503 to the account of the second entity system 507, and subsequently on to the account of the second user 509. In other embodiments, the event resolution may comprise a determination that a processing error occurred to transmit too many funds in the original event, and therefore a particular amount of funds should be withdrawn from the account of the second user 509, placed in the account of the second entity system 507, and, in some embodiments, returned to the account of the first entity system 503.

Once the event resolution has been determined, the second entity system 507 may proceed to block 518 to automatically implement the event resolution without requiring additional permission, comments, approvals, or other authorizations. Because the clearing house system 505 pre-authorization from both the first entity system 503 and the second entity system 507, resolution transactions can occur in real time (or near real time) once an entity determines that a processing error was made. In this way, the second user 509 can be made whole in real time, instead of having to contact the second entity system 507, the first entity system 503, and/or the first user 501 individually to determine whether an issue in the transaction has occurred and how to resolve the issue.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

### INCORPORATION BY REFERENCE

To supplement the present disclosure, this application further incorporates entirely by reference the following commonly assigned patent applications:

| | U.S. Patent | | |
|---|---|---|---|
| Docket | Application | | |
| Number | Ser. No. | Title | Filed On |
| 8867US- | To be assigned | REAL-TIME OBJECT | Concurrently |
| 1.014033.3395 | | IDENTIFICATION | herewith |
| | | AND TRACKING | |
| | | NETWORK | |

1. A system for real-time resource split distribution, the system comprising:
a memory device; and
a processing device operatively coupled to the memory device, wherein the processing device is configured to execute computer-readable program code to:
identify objects requiring upstream or downstream resource distribution upon event execution;
generate coordinated resource distribution schedules for the upstream or downstream resource distributions;
identify an event execution and object deployment;
generate a request for information message tag within a real-time network associated with the event execution and object deployment, wherein the request for information tag comprises the coordinated resource distribution schedules and is carried along with the resource distribution upon event execution; and
deploy split resources from the event execution and object deployment to multiple entities based on data associated with the request for information tag carried along with the resource distribution upon event execution, wherein splitting resources comprises splitting resource distribution to multiple entities for the event execution.

2. The system of claim 1, wherein generating coordinated resource distribution schedules for the upstream or downstream resource distributions further comprises identifying terms for resource distribution between upstream or downstream entities and the user, and conforming the terms to the coordinated resource distribution schedule, wherein the terms include a resource amount and an account for resource distribution.

3. The system of claim 1, wherein the upstream or downstream resource distributions include distributions to upstream or downstream entities associated with constructing or distributing the object for event execution and object deployment.

4. The system of claim 1, wherein the event execution and object deployment further comprises a product or service that require one or more upstream or downstream entities to be provided resources when the object is transacted for by a user.

5. The system of claim 1, wherein the request for information message associated with the real-time payment network further comprises a secure messaging platform for transmission of coordinated resource distribution schedules.

6. (canceled)

7. The system of claim 1, wherein deploying of split resources from a single event execution and object deployment to multiple upstream or downstream entities based on decryption of the coordinated resource distribution schedules further comprises real-time distribution of resources to one or more accounts associated with the multiple upstream or downstream entities directly from a financial institution.

8. A computer program product for real-time resource split distribution, the computer program product comprising at least one non-transitory computer-readable medium having computer-readable program code portions embodied therein, the computer-readable program code portions comprising:
an executable portion configured for identifying objects requiring upstream or downstream resource distribution upon event execution;
an executable portion configured for generating coordinated resource distribution schedules for the upstream or downstream resource distributions;
an executable portion configured for identifying an event execution and object deployment;
an executable portion configured for generating a request for information message tag within a real-time network associated with the event execution and object deployment, wherein the request for information tag comprises the coordinated resource distribution schedules and is carried along with the resource distribution upon event execution; and
an executable portion configured for deploying split resources from the event execution and object deployment to multiple entities based on data associated with the request for information tag carried along with the resource distribution upon event execution, wherein splitting resources comprises splitting resource distribution to multiple entities for the event execution.

9. The computer program product of claim 8, wherein generating coordinated resource distribution schedules for the upstream or downstream resource distributions further comprises identifying terms for resource distribution between upstream or downstream entities and the user, and conforming the terms to the coordinated resource distribution schedule, wherein the terms include a resource amount and an account for resource distribution.

10. The computer program product of claim 8, wherein the upstream or downstream resource distributions include distributions to upstream or downstream entities associated with constructing or distributing the object for event execution and object deployment.

11. The computer program product of claim 8, wherein the event execution and object deployment further comprises a product or service that require one or more upstream or downstream entities to be provided resources when the object is transacted for by a user.

12. The computer program product of claim 8, wherein the request for information message associated with the real-time payment network further comprises a secure messaging platform for transmission of coordinated resource distribution schedules.

13. (canceled)

14. The computer program product of claim 8, wherein deploying of split resources from a single event execution and object deployment to multiple upstream or downstream entities based on decryption of the coordinated resource distribution schedules further comprises real-time distribution of resources to one or more accounts associated with the multiple upstream or downstream entities directly from a financial institution.

15. A computer-implemented method for real-time resource split distribution, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
identifying objects requiring upstream or downstream resource distribution upon event execution;
generating coordinated resource distribution schedules for the upstream or downstream resource distributions;
identifying an event execution and object deployment;
generating a request for information message tag within a real-time network associated with the event execution and object deployment, wherein the request for information tag comprises the coordinated resource distribution schedules and is carried along with the resource distribution upon event execution; and
deploying split resources from the event execution and object deployment to multiple entities based on data associated with the request for information tag carried along with the resource distribution upon event execution, wherein splitting resources comprises splitting resource distribution to multiple entities for the event execution.

16. The computer-implemented method of claim 15, wherein generating coordinated resource distribution schedules for the upstream or downstream resource distributions further comprises identifying terms for resource distribution between upstream or downstream entities and the user, and conforming the terms to the coordinated resource distribution schedule, wherein the terms include a resource amount and an account for resource distribution.

17. The computer-implemented method of claim 15, wherein the upstream or downstream resource distributions include distributions to upstream or downstream entities associated with constructing or distributing the object for event execution and object deployment.

18. The computer-implemented method of claim 15, wherein the event execution and object deployment further comprises a product or service that require one or more upstream or downstream entities to be provided resources when the object is transacted for by a user.

19. The computer-implemented method of claim 15, wherein the request for information message associated with the real-time payment network further comprises a secure messaging platform for transmission of coordinated resource distribution schedules.

20. (canceled)
